(19) United States
(12) Patent Application Publication
(10) Pub. No.: US 2014/0098920 A1
(43) Pub. Date: Apr. 10, 2014

(54) METHOD FOR THE PRODUCTION OF RENEWABLE HEAT ENERGY

(71) Applicant: György Egely, Budakeszi (HU)

(72) Inventor: György Egely, Budakeszi (HU)

(21) Appl. No.: 14/118,458

(22) PCT Filed: May 24, 2012
(86) PCT No.: PCT/HU2012/000043

§ 371 Date: Nov. 18, 2013

(30) Foreign Application Priority Data
Jun. 1, 2011 (HU) P1100287

(51) Int. Cl. G21D 9/00

(52) U.S. Cl. CPC G21D 9/00
USPC 376/201

(57) ABSTRACT

The subject of the invention is a process for heat production with nuclear interactions. During the process the gas is pumped through a stack of nanoparticles in a device featuring an internal and an external chamber via an inlet and an outlet opening, and the process is initiated by heating the device. Further, the subject of the invention is a device accomplishing said process. The device has an interconnected internal chamber, and surrounding said chamber there is an external chamber having at least one inlet and one exit opening. There are nanoparticles in the internal chamber. There is an impermeable wall between the two said chambers. The internal chamber is separated from the exit opening by a heat resistant, porous ceramic wall. There is a heating element on the internal side wall.

The invention is a method for renewable energy production with a nuclear process, when a gas flows through a stack of nanoparticles in a device featuring an internal and an external chamber, with ports on both inlet and an outlet side. The process is started by heating the system to its operating temperature. A further subject of the invention is a device for the production of renewable heat thermal energy with gas and nanoparticles. The device comprises internal and external chambers, with at least one inlet and one outlet opening. A control unit is an inherent part of the system.

In most households, heating is accomplished by the burning of hydrocarbons. The disadvantages are well known, and there is an urgent need to shift to inexpensive renewable energy.

It is possible to produce heat by fission materials such as thorium and uranium. While it could be safe and economical for large urban areas, given the mass emotional resistance of public opinion, its widespread use is unlikely. Nature offers another possibility. Fusion reactions, based on strong nuclear interaction have not yet been achieved (like the Laser-ignited or TOKAMAK type) despite intensive research efforts.

However there is a third way based on electroweak interactions, barely known even to interested scientists. This has to do neither with hot fusion nor with “cold” fusion. What is it that sets it apart?

There is a branch of controlled nuclear fusion, which has been researched since 1989. It proved to be a mistake to look for the same reaction of D+D→He³+x+γ (gamma) as it happens in the hot fusion, based on strong interactions. The attempt to create fusion of deuterium nuclei in the regular crystal lattice of palladium proved to be a futile one. “Cold fusion” was attempted usually by precipitating deuterium onto a palladium cathode during electrolysis at 40-80° C. in an aqueous solution. However, the small amount of excess heat that was measured and the nuclear transmutation should be explained by a different mechanism and, accordingly, another technical device needed to be discovered, more suitable for this new effect. The process and device described by our invention is markedly different from either the “hot” or “cold” fusion, from the physical foundations to its practical achievement.

In some cases, excess heat was detected with light water during nuclear interactions, but it was based on a different mechanism. The device and process of James Patterson was granted U.S. Pat. No. 5,372,688.

This nuclear heat production only takes place when a thin layer of palladium or nickel contains such contamination that produces small cracks on the metal surface. It has hitherto been unnoticed, as it is visible only under an electron microscope, and therefore had received no attention. When the cathode got saturated with hydrogen and the surface became cracked, the experiments were successful; otherwise it failed. This is hard to control technically, and is influenced by heat treatment and milling methods during manufacturing.

The present invention was rendered possible by the realization that experiments have come to highlight the importance of both process temperature and surface quality. The importance of temperature was shown by those tests, when the electrolysis was switched off due to local overheating. (A phenomenon that is referred to as the “heat after death” effect).

In the “conventional cold fusion”, process the fusion reaction of deuterium nuclei was sought inside of a palladium crystal lattice. This was proven wrong.

The heat production effect takes place on nano-sized conductive surfaces due to the resonant field amplification effect of thermal radiation. Then, free electrons and protons of dilute hydrogen plasma combine into ultra-cold neutrons due to this high electric field intensity and, according to our assumption by searching for the nearest nuclei, nuclear reaction takes place.

Technically, when subjected to intense thermal radiation, nano-sized grain particles or layers are suitable for this purpose. Therefore, nano-sized “components” having good electric conductivity are appropriate for this task, being attached to large surfaces.

The allotrope forms of carbon are especially suitable to form useful nano particles, for example closed spheroidal, multilayer formations heavier than C60, like C540, or mostly in nanotubes.

This invention was made possible also with the realization that such nano-sized carbon particles are easy to manufacture in a gas discharge.

Carbon nanotubes are produced industrially mainly in low-pressure argon gas with a discharge of graphite electrodes. These particles are already present in the flame soot of candles, albeit only in very small quantities, because most of the soot is irregularly formed. However, periodic heating/cooling cycles are especially favorable to form nanotubes.

I have filed a Hungarian patent application in this area under P1100247, where the invention was partially based on this effect. With this previous solution, carbon nano particles are formed continuously in the device. During this process, closed-surface carbon particles, large irregular molecules and nanotubes are formed as well. Of the latter, only two-thirds will be good electrical conductors; the rest are semiconducting, which is of little use for our purpose. Semiconducting nanotubes are unsuitable to form a surface or volumetric plasmon polaritons, which is essential to generate a heat producing nuclear effect according to our model and experience.

Fortunately, the field of nanotechnology is rapidly evolving, with new industries taking shape and the number of publications rapidly growing. Approximately 8,000 papers have been published about carbon nanotubes, and there are encyclopedic monographs on the subject nearly every year. These references describe the types of carbon nanoparticles that are formed in resonant atmospheric reactive plasma, described in our invention and disclosed in our patent application of P1100247. These are mostly multi walled tubes but with “bud-like” defects. Sometimes they resemble pearls on a string. These “pearls” are of no longer regular hexagonal grids, but are amorphous forms, due to their fast cooling. However, the regular parts are suitable for the creation of the heat producing effect.

This invention was made possible with the recognition that such nanotubes are already commercially available, and no longer constitute lab curiosities. There are several vendors on the market with a wide range of qualities. (Multi walled nanotubes typically cost $250 per kg.)

When the task is to produce inexpensive heat, and there is no need for the apparatus to be portable, multi walled conductive nanotubes are a good choice. (Their conductivity is a thousand times better than that of copper. The current density could be up to 10¹³ A/cm² for a perfect nanotube) Up until recently, such high conductivity rates and the associated high tensile strength had been unimaginable for a design engineer of the “macroscopic” world.

Although we are unable to produce long tubes, fortunately there is no need for them either, since a tube of one micron in length is more than sufficient.

Thus we have recognized that intense heat is necessary (some hundreds of ° C.) for our invention and a surface some tens of nanometer thick with good electrical conductivity, where the dissipation of electromagnetic oscillation is less pronounced. Half or one-third of multi walled tubes are suitable for this purpose. Although some of the nanotubes are semiconductive or of amorphous “garbage”, or fullerens of little use, they do not present risks to the effect. The fuel is partly inert gas, and hydrogen isotopes. As only a small amount is required and it is abundant, it is duly considered as a renewable fuel source. Not only carbon nanotubes are suitable to form surface and volumetric plasmon polaritons. Up to about 400° C., precious metals, copper, nickel, palladium, chromium or vanadium particles, as well as their alloys are also suitable. In the Middle Ages, gold and copper colloids were added to the glass of cathedral window panes, which caused optical amplification and a shift in color. Surface plasmon polaritons may form even on the surface of micron sized metal particles due the intense heat radiation.

This effect is utilized by A. Rossi, described in his US patent application 2011/0005506/A1. It is claimed the usual grain size is about 10 μm, of dense Ni dust, with an average 8-fold energy gain.

However, it is possible to improve the energy if, instead of the characteristically 10 μm diameter nickel grains that were used by Rossi, a layer some ten nanometers thick of copper, precious metal, nickel chromium or vanadium is used on metal oxide grains with heat resistive properties. The field amplification capability is much stronger in a thin metal layer of some tens of nanometers, due to the presence of resonant surface plasmon polaritons. Therefore, in tubes with diameters of a few centimeters, or on flat surfaces, there is enough volumetric heat generation to satisfy practical needs provided there is intensive cooling. As a result, smaller and less expensive machines can be built. This is one of the advantages of our method and device. Besides multi walled carbon nanotubes, thin metal layers (as well as metal oxide layers) are also useful for heat production. Such thin metal layers are relatively easy to produce even on an industrial scale, such as by condensation of metal vapors.

Our invention is a process for renewable heat generation with nuclear interaction. Consequently, a gas medium flows through a device featuring internal and external chambers and having at least one entry and one exit port, via a stack of nanoparticles. The process is started by heating the device. The nanoparticles consist of nanometer-to-μm-thick conductive metal layers epitaxially condensed (deposited) onto the surface of ceramic grains, advantageously with diameters of 10-20 μm. We use electrically insulating metal oxides as the material for grains, where gold, silver, copper, chromium, nickel, or vanadium is deposited expitaxially, or according to our invention, we may deposit a layer of carbon nanotubes at least 10 nanometers in diameter.

Hydrogen/inert gas mixture is used as a coolant and fuel gas, partly as ionized, and partly in a monoatomic and molecular form. The nanoparticles are placed into the internal chamber. The gas is introduced via the inlet port and outer chamber, into the inlet chamber, and the hot gas leaves the inlet chamber via a ceramic wall that is permeable for the gas but non-permeable for the nanoparticles, in order to utilize the hot gas. In order to start and maintain the process in the internal chamber, intensive heating is necessary, advantageously at temperatures ranging between 200 and 600° C. by infrared radiation or with ohmic heating using an electric resistance, while the gas flows through the device at pressures exceeding 100 Pa in order to maintain the heat producing nuclear reaction.

Further, our invention is a device to produce renewable heat energy with gas and nanoparticles. The device consists of an internal and an external chamber connected to it, and features at least one inlet and one outlet opening. An electronic control unit is connected to the device. There are electrically insulating nano-sized or micron-sized grains, and electrically conductive metal layers are deposited on their surfaces epitaxially, at nanometer or micrometer thickness. Between the outer and inner chambers is a partially separating wall, impermeable to gases. The inner chamber is separated from the exit outlet tube by a heat resistant porous ceramic wall. There is a heating element outside the internal chamber on its wall. Advantageously a spiral cooling tube runs on the outer wall of the internal chamber, filled with high-pressure water, oil or liquid metal, as a secondary cooling device advantageously as a cylindrical spiral, having an inlet and outlet opening via the outer chamber wall.

In order to avoid overheating the outer chamber wall and to reduce the diffusion of coolant gas though it, the inner wall of the outer chamber is covered suitably by either a Teflon or silicon layer, which in turn is blanketed with a thermal insulation layer permeable to gas.

Between the exit and inlet tubes is the primary side of a heat exchanger, while the secondary side is filled with water or with an inert gas. In another embodiment to run an external combustion heat engine, there are additional circulation pumps on both tubes.

There is another circulation pump in the second coolant circuit, preferably near its inlet or outlet opening, or even within the outer chamber.

There is a high-pressure gas cylinder connected by a tube, preferably at the inlet opening of the external chamber, along with a pressure reducing valve and an emergency blowdown valve.

There is a thermal sensor in the internal chamber, connected to the control unit. The control unit may activate the emergency blowdown valve and regulates the pump power. The tubes may be equipped with safety valves, tripped by pressure transducers.

### BRIEF DESCRIPTION OF THE DRAWINGS

FIG. 1/a is a schematic drawing of a nanoparticle, in the coolant gas, where the conductive metal layer is Cu, Au, Ag, Ni or Cr and/or their oxides.

FIG. 1/b is a schematic drawing of nanoparticles in the coolant gas, where the particles are made of multi walled carbon nanotubes.

FIG. 2/a is a schematic drawing of a nanoparticle of FIG. 1/a, radiated by a transverse electromagnetic field, where the metal layer is Cu, Au, Ag, Ni or Cr and/or their oxides.

FIG. 2/b is a schematic drawing of a resonant surface plasmon polariton in an ambient electromagnetic field shown in FIG. 2/a.

FIG. 2/c a schematic drawing of a nanoparticle in an electromagnetic wave, where the conductive layer is made of multi walled carbon nanotubes.

FIG. 2/d is a schematic drawing of a resonant surface plasmon polariton due to the effect shown in FIG. 2/c.

FIG. 3/a represents a cross-sectional view of an advantageous embodiment of the invention, as well as the temperature distribution as a function of the radius.

FIG. 4 is a schematic drawing of a possible embodiment of the invention.

### DESCRIPTION OF SPECIFIC EMBODIMENTS

### Overview

The method according to our invention is renewable heat production by means of a nuclear process, and embodiments to achieve it in practice. The fundamentals of our process have been disclosed above, where the heat production effect takes place on nanometer-sized surfaces triggered by infrared radiation and amplified by a resonant electromagnetic field. Then, free electrons and protons from hydrogen and inert gases due to this amplified field intensity combine into ultraslow neutrons, which in turn fuse into the nucleus of nanoparticles with electroweak interactions according to our opinion.

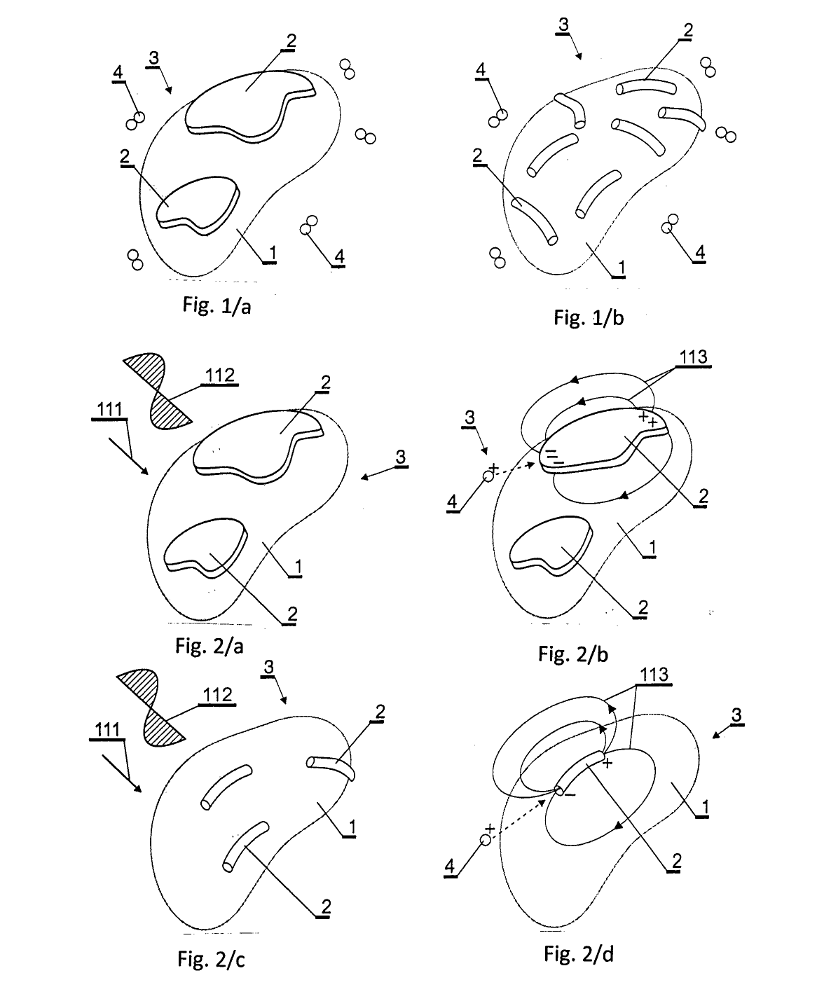

These phenomena are shown schematically in FIG. 1a-2d. In FIG. 1/a nanoparticle (3) is shown as a thin, micron or sub micron-thick layer (preferably between 10-100 nanometers) of a few micro millimeters in length, made of a layer of Cu, Au, Ag, Ni or Cr (2) and/or of their oxides. At these small scales, the oxides appear for the above-mentioned metals but are reduced in the gas environment of (4). Layer (2) does not cover the entire surface of a grain (1).

The hydrogen and inert gas mixture (4) is partly ionized, partly mono-atomic and partly in molecular form.

The nanoparticle (3) is formed in a manner similar to that shown in FIG. 1/a, where a layer of multi walled carbon nanotubes (2) is attached onto the surface of a grain (1), preferably at a thickness of 10-100 nanometers and a few micrometers in length. It is not necessary for the tubes (2) to cover the entire surface of a grain (1). The advantage of particles (3) made with carbon nanotubes (2) is that they withstand higher temperatures without losing their lattice structure (in a vacuum up to 2500° C., or at higher pressures, up to about 600° C.).

At these characteristic geometric sizes the stack made of nanoparticles (3) is still permeable by gas (4). The stack made of nanoparticles (1) shown in FIG. 1/a and FIG. 1/b could be loose in bulk as an example. The grains (1) may physically contact one another; therefore, they are permeable by the coolant medium gas (4).

The coolant gas (4) is partly hydrogen. It is shown in FIG. 2/a where a transversal electromagnetic wave of terahertz order (112) coming from direction (111) excites a nanometer thick metal layer (2) attached epitaxially onto the surface of particle (1), made of e.g. Ag, Au, Cu, Ni or Cr.

FIG. 2/b shows schematically that, due to the excitation of the transversal electromagnetic waves (112), a surface plasmon polariton is formed on the metal layer (2), which is resonant under favorable parameters. Though it dissipates over time, in the meantime its negatively charged side attracts the positive ions of the medium (4) and commences collective oscillations, as well as with the electrons of layer (2).

The process, shown in FIG. 2/c and FIG. 2/d is similar to those shown previously in FIG. 2/a and FIG. 2/b. Although the conductive layer (2) is an embodiment with conductive carbon nanotubes, the excitation is also made by transversal waves (112).

FIG. 2/d shows that when a nanotube from layer (2) is excited by the impact of a positive proton, it gives rise to a volumetric plasmon polariton yielding a significant local field intensity (113).

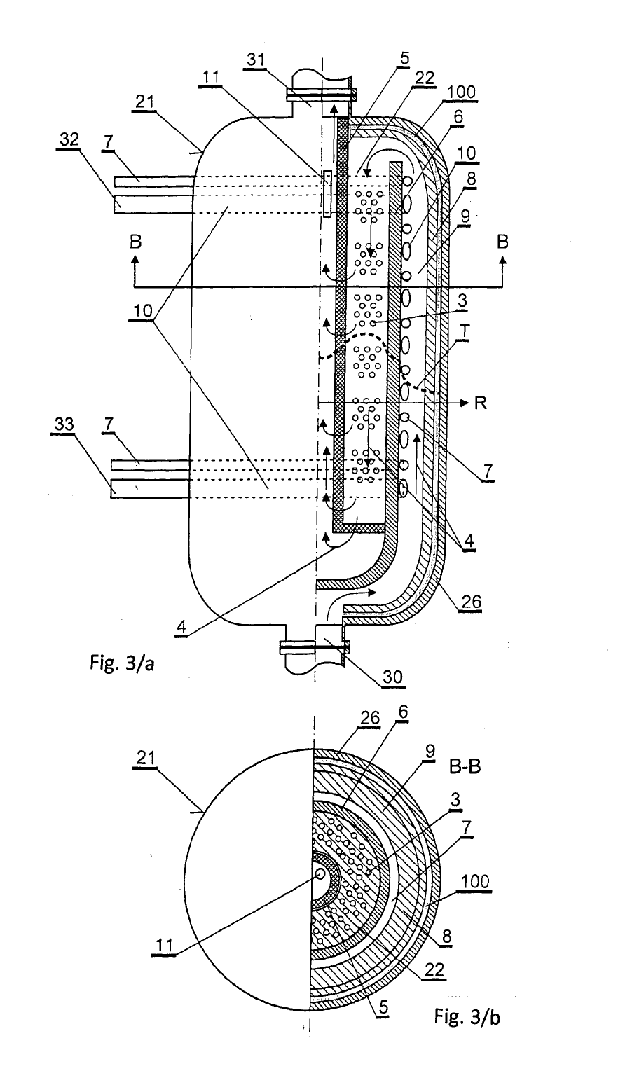

In order to commence the process shown previously in FIG. 1/a-to FIG. 2/d as a highly schematic embodiment of the present method of the invention, a mixture of hydrogen and inert gas (4) is pumped through the device (21), consisting of external chamber (9) and internal chamber (9) and having at least one inlet port (30) and exit port (31), where previously described nanoparticles (3) are arranged in a stack inside the internal chamber (22). Nanoparticles (3) could be attached to the surface of Raschig rings of a few millimeters in diameter, made of metal oxide ceramics in order to improve permeability. The gas medium (4) is pumped through the inlet (30) via the external chamber (9), into the internal chamber (22) along nanoparticles (3). Embodiment (21), as shown in FIG. 3/a, having an internal chamber (22) with a stack of nanoparticles (3) and a gas mixture (4) is warmed intensively up to a few hundreds of ° C., advantageously in the 200-600° C. range with an ohmic resistance or by means of infrared radiation. Nanoparticles (3) are made of electrically insulating metal oxide grains (1) with diameters of 10-20 micrometers, and are attached epitaxially to their surface is an electrically conductive layer (2) of nanometer or micron thickness. Grains (1) are made of electrically insulating metal oxides, and metals are epitaxially deposited as a layer (2) partially covering its surface, made of metals such as Ag, Au, Cu, Ni, Cr or vanadium, or multi walled, electrically conductive carbon nanotubes are used in the layer (2) on the surface of the grain. The coolant-reactant gas (4) is partly ionized, partly monoatomic, partly molecular hydrogen and inert gas. This mixture is pumped via the reactor, via the entry port (30) to the external chamber (9), and from there through the internal chamber (22) and a porous ceramic wall (6) towards the exit port (31), creating a heat producing nuclear reaction, above variable pressure levels of 100 Pa. The heat content of the gas mixture leaving the exit port (31) is used in a conventional manner, for example for heating or to drive an external combustion engine.

Embodiment (21) has been developed to create renewable heat. This invention (21) is shown schematically in FIG. 3 and FIG. 3/b. It consists of an internal chamber (22) encapsulated within an external chamber connected to it (9), having at least one inlet port (30) and one outlet port (31). Embodiment (21) is filled with nanoparticles (3) in the internal chamber (22). To fill up the internal chamber (23), the embodiment (21) can be dismantled along its full cross section with bolts as an example, or a dust inlet port is created for nanoparticles (3) on the external wall of embodiment (21). This is not shown as it is obvious for those skilled in pressure vessel construction.

Nanoparticles (3) consist of electrically insulating dust grains with diameters in the nanometer to micron range, and on the surface of these grains there is an epitaxially deposited conductive metal layer (2) of a few nanometers or micrometers thick, thus creating the embodiment (3). There is an impermeable wall (6) for the gas mixture between external (9) and internal (22) chambers, partially separating them, and there is a gas-permeable ceramic wall (5) between the exit port (31) and the internal chamber (22). There is a heating element (7) on the external wall of the internal chamber.

A further possible embodiment of the invention is made from auxiliary elements shown in FIG. 3/a and FIG. 3/b. There is a secondary cooling element (10) filled with high-pressure water, oil or liquid metal in the form of a spiral tube, on the opposite side of the wall (6) of the internal chamber (22), where the inlet port (14) and exit port (9) penetrate the wall of the external chamber (9).

In order to reduce the overheating of the external chamber (9), and to decrease the diffusion of the gas mixture (4), the internal wall of the chamber (9) is covered with a thin layer of heat resistant Teflon or silicon (100), which is covered by a heat insulating layer (8) permeable for gas mixture (4). There is a thermal sensor (11) in the internal chamber (22).

In embodiment (21) there is a flow of a mixture of an inert gas/hydrogen (4) (serving both as the primary coolant and also as the fuel) along both sides of the ceramic wall (5), as shown in FIG. 3/a and FIG. 3/b. The heat sensor (11) monitors the temperature of the mixture (4). The permeable stack of nanoparticles (3) is placed between the wall (6) and the ceramic wall (5), cooled by the gas mixture (4). On the outer side of the wall (6) there is a heating element (7), necessary to start the process. In a possible embodiment of our invention, there is an ohmic resistor on the wall (6) of the internal chamber (22). A secondary coolant device (10) is placed on the outside of the wall (6) as part of the secondary cooling circuit. The external chamber (9) is a stainless steel pressure vessel. A cold coolant mixture enters via the inlet port (30) into embodiment (21), and the gas coolant heated by the nuclear reaction (4) is discharged via the exit port (31).

A cylindrical arrangement is shown in FIG. 3/a and FIG. 3/b. In another embodiment of the invention, it is possible to use flat plates. For those skilled in this field, designing several versions of the invention based on its underlying process should present no significant problems.

The temperature distribution is shown in FIG. 3/a along a radius. It is obvious that the temperature will peak inside the internal chamber (22). Consequently, the sensor cannot measure temperature peaks, only a lower value.

A possible schematic embodiment is shown for the invention (21), including the cooling and electronic control.

In this preferable embodiment, on the primary side of the heat exchanger (13) a tube (23) is placed between the internal (30) and the external (31) ports, while the secondary side (20) of said heat exchanger is filled with water or an inert gas to run an external combustion engine, further there is a pump (12) in said tube (23).

There is a second pump (25) within the external chamber (9) as a possible embodiment of the invention in the secondary coolant circuit (10) near the inlet (32) and exit (33) ports.

Embodiment (21) is connected to a high-pressure cylinder (16) in order to store and inject the fuel mixture (4), via a pressure reducing valve (17) and tube (23), into the inlet port (30). Embodiment (21) for renewable heat production is regulated by an electronic circuit (18). The output of the circuit (18 is connected to an emergency blowdown valve (19) and to the input of the power regulator of the circulating pump (12). There is a membrane safety valve (24) or pressure limit gauge.

Hot gas (4) leaves the steel external chamber (9) via the outlet port (31). The gas mixture (4) may leave via the safety valve (24). Most of the heat generated in the chamber (9) is transferred from the primary side (13) to the secondary side (20), where a heat utilization device could be connected (such as a Stirling engine), between the inlet (14) and the outlet (15) ports. This is not shown for the sake of simplicity. A circulation pump (12) turns the gas mixture (4). A high-pressure cylinder (16) stores the mixture of hydrogen/inert gas (4). The gas mixture (4) is then fed to embodiment (21) via a pressure reducing valve (17) and an emergency blowdown valve (19) into the inlet port (30). The system is controlled by an electronic unit (18), which heats and regulates it. The control is carried out along the wires drawn by the dashed line, connected to the control unit (18) and to sensors and actuators. The control unit (18) is connected electrically to a heat sensor (11), circulating pump (12) and emergency blowdown valve (19). The control unit (18) closes and opens the blowdown valve (19), and regulates the throughput of the circulating pump (12) for the gas mixture (4).

### Brief Description of the Process and Embodiment of the Invention

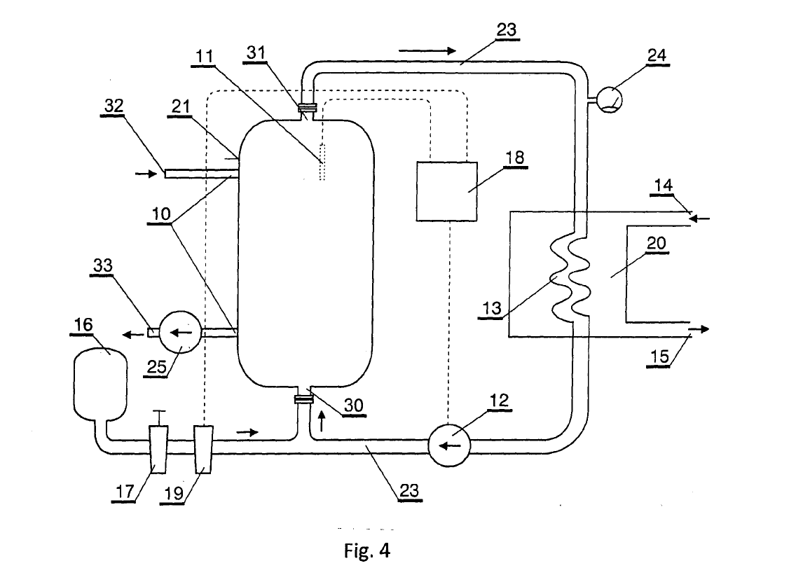

In one possible embodiment of the invention shown in FIG. 4, the system is operated first by filling the internal chamber (22) with a stack of nanoparticles (3). The gas mixture (4) is pumped through this stack, after removing oxygen from the embodiment (21). Then the embodiment (21) is heated to its operating temperature by an ohmic resistor (7), after which the heat producing reaction will commence. Therefore, the gas mixture (4), serving both as coolant and fuel, must be circulated. In our invention, hydrogen (4) is diluted with an inert gas, such as helium or nitrogen. Thus, cooling is maintained yet the number of energy producing reactions is restricted, because hydrogen isotopes participate in heat producing reactions. When the thin metal layer (2) is used on the grain, the maximum temperature in the grain stack might exceed 300-400° C. (The mixed gas discharging from the system might be cooler.) At 300-400° C. there is a small amount of ionization. (This is a complicated process. For details, refer to L. S. Garcia, Colin, L. Dagdug: “The Kinetic Theory of Dilute Ionized Plasma”. Springer, 2009.)

When the layer (2) is made of carbon nanotubes, peak temperatures of 400-500° C. still might be used. At this temperature, the ionized gas accounts for one or two thousandth of the plasma, thus free protons are created for the reactions.

There are more active elements per volume in this invention than in a hot, fully ionized plasma, though their specific heat producing capacity is lower. During the operation of embodiment (21), the stack of nanoparticles (3) is placed into the internal chamber (22) permeated by gas (4), where hydrogen gas produces the heat. Our experiments show that hydrogen gas is suitable for this purpose, though one out of every 6,000 nuclei turns out to be deuterium instead of a proton. As a means of controlling the stack temperature, some of the reaction heat is removed with the secondary cooling element (10). After the startup, the production of heat begins and it is continuous. After the initial heating, the reaction is self-sustaining and must be cooled to avoid local overheating, as it can damage the thin layers. The layer (2) of nanotubes is better suited for this purpose. Further the auxiliary devices will be described schematically, because they are well known technical solutions.

Embodiment (21) is an example of the invention, constructed so that the internal wall of the external chamber (9) is covered by a porous, permeable layer (8) of heat insulating material to mitigate the warming of the corrosion and the diffusion of hydrogen. This heat resistant layer (100) is placed between layer (8) and the external chamber (9). Arrows in FIG. 3/a indicate the direction of the coolant flow.

After entering inlet opening (30), the gas mixture (4) is heated and leaves via the ceramic wall (5), and then enters the heat exchanger (13) and transfers its heat to the secondary side of the heat exchanger (20).

The coolant in the secondary side (20) enters via the inlet opening (14) and leaves via the outlet opening (15). There is a similar cooling method for the secondary cooling loop (10), where the coolant is circulated by a secondary cooling pump (25). This cooling circuit can be linked to the main cooling circuit, but it is not shown for the sake of simplicity. The heat generated in the device is used for heating or to run external combustion engines.

Embodiment (21) is filled with gas (4)—a mixture of hydrogen and an inert gas —from a high-pressure cylinder via pressure reductor (17). The emergency blow down is executed by a “T” shaped (19) double-position valve. In one position of the valve (19) the gas mixture (4) enters the system. In the other position, it blows down. There is a fracturing membrane emergency blowndown safety valve (24), to make sure that system pressure never exceeds its maximum value.

Control unit (18) heats up the system. It also regulates the throughput of the pump (12) blowndown valve (19) based on the temperature signal received from the heat sensor (11). The actuator and sensor wirings are shown with dashed lines in FIG. 4.

By increasing the throughput of the circulating pump (12), (the mass flow rate of the gas (4)), the cooling effect is accelerated, the reaction power density is decreased, or may stop altogether. Then, the device must be restarted as described earlier.

Control unit (18) opens and closes the emergency blowdown valve (19). This valve (19) allows the gas (4) to enter embodiment (21) via the entry port (30), or, in case of emergency, allows for a quick alarm stop.

The heat producing capability of embodiment (21) is fine-tuned by changing the cooling capacity of the secondary cooling system (10). The temperature distribution as the function of radius is shown in FIG. 3/a, and our aim is to keep the wall temperature of the external pressurized chamber (9) at room temperature in order to reduce hydrogen corrosion, thus expanding the duration of safe operation. When carbon nanotubes are used, a core radius of a few cm is enough to maintain a 5-6 KW thermal output, which is sufficient for practical purposes.

According to our experience, a power density of 1 KW/dm³ can be maintained with carbon nanotubes and hydrogen gas, with a 400° C. exit temperature.

The embodiment of the invention could be used in other geometric forms. Any similar system might be constructed according to our disclosure, which could be made by those skilled in this art.

1. Process to produce renewable heat energy by a nuclear process, where gas (4) is pumped through a stack of nanoparticles (3) via an embodiment (21) featuring an external (9) and internal chamber (22) and at least one port on each of inlet (30) and outlet (31) sides, and the process is started by heating said embodiment, characterized by nanoparticles (3) consisting of nanometer to micrometer size metal oxide grains, advantageously 10-20 micrometers in diameter (1) and an electrically conductive, epitaxially deposited metal layer advantageously 2 to 20 nanometers thick, made advantageously of either gold, silver, copper, chromium, nickel or vanadium, on the surface of said grain particles, partially covering said grain (1) surfaces, or multi walled, electrically conductive carbon nanotubes, in excess of 10 nanometers in diameter, are deposited on said particles (1), and the gas (4) is partially ionized, partly monoatomic, partly molecular hydrogen and an inert gas it is pumped through a stack of said nanoparticles (3) which are in the internal chamber (22), after entering via the inlet port (30) and flow along an external chamber (9) then flow into said internal chamber (22), discharging via a ceramic wall (5) that is permeable by gas (4) and impermeable by nanoparticles (3), and the heated gas is led via the exit port (31) for utilization, and said process is initiated by heating said internal chamber (22) to temperatures of advantageously 200-600° C. by infrared radiation or with an ohmic resistance, while gas (4) is pumped through said embodiment at variable pressures above 100 Pa to ignite heat producing nuclear reactions.

2. Embodiment for renewable heat production with a gas mixture (4) and nanoparticles (3), said embodiment (21) comprising an internal chamber (22) and an external chamber connected to it (9), and featuring at least one inlet port (30) and exit port (31), regulated by an electronic unit (18) characterized by a stack of nanoparticles (3) in the said internal chamber (22), whereby said nanoparticles consist of electrically insulating metal oxide ceramic particles, nanometers or microns in diameter, and on the surface of said particles there is an electrically conductive layer epitaxially deposited with a thickness advantageously in the nanometer to microns range (2), and there is an impermeable wall for gases (6) between the internal chamber (22) and the external chamber (9); the internal chamber (22) is separated from the exit port (31) by a heat resistant porous ceramic wall (5); further on the outside of chamber (22) of said wall (6) there is a heating element (7).

3. Embodiment of the claim (2), characterized by a secondary cooling element (10) on the outside of wall (6) of an internal chamber (22), preferably of spiral shape and filled with water, or oil, or liquid metal, having an inlet (32) and an outlet (33) port, penetrating through the wall of the external chamber (9).

4. Embodiment according to claim 2, characterized by a thin heat resistant layer (100) made conveniently of Teflon or silicon to protect the external wall of the external chamber (9) from overheating and diffusion of the gas mixture (4).

5. Embodiment according to claim 4 characterized by a heat insulation layer (8) permeable by a gas mixture (4) forming the heat resistant layer (100).

6. Embodiments according to claim 2 characterized by a primary side of a heat exchanger (13) with a duct (23) between the inlet (30) and outlet ports of said embodiment, having a pump (12) inside said duct (23), and a secondary side of said heat exchanger filled with water or inert gas conveniently to run an external combustion engine.

7. Embodiments according to claim 2 characterized by the secondary coolant cycle (10) having a second coolant pump (25) within the secondary chamber, conveniently between the inlet (32) and outlet (33) ports.

8. Embodiments according to claim 2 characterized by a high-pressure cylinder (10) to store a high-pressure gas mixture (4), which is connected to said embodiment via a pressure reducing valve (17) and an emergency blowdown valve (19) into a tube (23) near the inlet port (30).

9. Embodiments according to claim 2 characterized by a heat sensor (11) in the internal chamber (22), wherein said heat sensor is connected to the input of the control unit (18), and the output of said control unit is connected to the sensor of the emergency blowdown valve (19) and the circulation pump (12).

10. Embodiments according to claim 6 characterized by a safety membrane cracking valve (24) which is connected to the main circulation tube (23).
